(19) United States
(12) Patent Application Publication
(10) Pub. No.: US 2026/0243692 A1
(43) Pub. Date: Aug. 20, 2026

(54) BIOMARKER DETECTION USING SURFACE-ENHANCED INFRARED SPECTROSCOPY

(71) Applicants: AGENCY FOR SCIENCE, TECHNOLOGY AND RESEARCH, Singapore (SG); SINGAPORE HEALTH SERVICES PTE LTD, Singapore (SG)

(72) Inventors: Shuyan ZHANG, Singapore (SG); Dinish UNNIMADHAVA KURUP SOUDAMINI AMMA, Singapore (SG); Jayakumar PERUMAL, Singapore (SG); Malini OLIVO, Singapore (SG); Yi Fan CHEN, Singapore (SG); Qing Yang Steve WU, Singapore (SG); Jinghua TENG, Singapore (SG); Ann Siew Gek LEE-LIM, Singapore (SG); Melissa Wen Ching HUM, Singapore (SG)

(21) Appl. No.: 19/164,616

(22) PCT Filed: Mar. 12, 2024
(86) PCT No.: PCT/SG2024/050148

§ 371 Date: Sep. 12, 2025

(30) Foreign Application Priority Data
Mar. 13, 2023 (SG) 10202300681W

(51) Int. Cl. G01N 21/78; G01N 21/35; G01N 21/77

(52) U.S. Cl. CPC G01N 21/78; G01N 21/35; G01N 2021/3595; G01N 2021/7773

(57) ABSTRACT

A method includes determining a first change from a first FTIR spectrum of bare SEIRA structures to a second FTIR spectrum of SEIRA structures bound with complementary molecules; determining a second change from the second FTIR spectrum to a third FTIR spectrum of SEIRA structures bound with the complementary molecules and the target molecules; and determining a presence and/or a concentration of the target molecule. The method may include determining an area ratio indicative of a concentration of the target molecule. A device includes a plurality of wells to receive an amount of the sample. Each well is isolated from any other of the plurality of wells. A SEIRA sensor is disposed in each well, in which the SEIRA sensor is configured with a resonant response in a plurality of resonant peak frequencies distributed over a range of frequencies.

### RELATED APPLICATION

This application claims the benefit of priority to the Singapore application no. 10202300681W filed Mar. 13, 2023, the contents of which are hereby incorporated by reference in their entirety for all purposes.

### TECHNICAL FIELD

The present application relates to surface-enhanced infrared spectroscopy (SEIRA) and more particularly to a method of biomarker detection.

### BACKGROUND

Breast cancer is one of the most commonly diagnosed cancer globally. The current approach for screening breast cancer in asymptomatic individuals is mammography. Although mammography is deemed the gold standard for breast cancer screening, it has many well-recognized shortcomings, such as high false-positive results, overdiagnosis, etc. As much as 11-13% of all screening mammograms are abnormal and as little as 0.5% of all screening mammograms are true-positives. A person with an abnormal mammogram has therefore an approximately 96% change of having a false-positive result. Persons with false-positive mammograms are subjected to unnecessary additional diagnostic imaging tests and tissue biopsies, which are highly stressful, invasive, and expensive. There is clearly a need for a better diagnostic method.

### SUMMARY

In one aspect, a method of testing a sample includes: acquiring a first Fourier transform infrared (FTIR) spectrum from a surface-enhanced infrared absorption (SEIRA) sensor; acquiring a second Fourier transform infrared (FTIR) spectrum from a surface-enhanced infrared absorption (SEIRA) sensor bound with a molecule complementary to a target molecule; acquiring a third FTIR spectrum from the SEIRA sensor after providing the sample to the SEIRA sensor; determining a first change from the first FTIR spectrum to the second FTIR spectrum; determining a second change from the second FTIR spectrum to the third FTIR spectrum; and based on the first change and the second change, determining a presence and/or a concentration of a target molecule in the sample, wherein each of the first change and the second change includes a change in intensity across a range of frequencies.

The method in which the determining of the presence and/or the concentration of the target molecule in the sample includes determining an area ratio, in which the area ratio is a ratio between the area under the first change and the area under the second change, and in which the area ratio is indicative of a concentration of the target molecule in the sample.

In another aspect, a device for testing a sample includes: a plurality of wells, each of the plurality of wells being at least partially circumscribed by a physical barrier to prevent fluidic communication through the physical barrier between the adjacent ones of the plurality of wells. The device includes a surface-enhanced infrared absorption (SEIRA) sensor disposed in each of the plurality of wells, in which the SEIRA sensor is configured with a resonant response in a plurality of resonant peak frequencies distributed over a range of frequencies.

### BRIEF DESCRIPTION OF THE DRAWINGS

Various embodiments will be described with reference to the following figures:

FIG. 1A is a schematic diagram showing a side view of a SEIRA sensor and infrared interaction thereat;

FIG. 1B is a schematic drawing showing a system including an FTIR microscope for data collection from a sensor chip;

FIG. 2A is a schematic cross-sectional view of a part of the proposed sensor chip;

FIG. 2B is a schematic perspective view of one example of the proposed sensor chip showing a multi-well configuration with a plurality of wells in rows and columns;

FIG. 3A shows the ATR-FTIR measurements of DNA, miRNA, and water solution samples under atmospheric conditions;

FIG. 3B shows the ATR-FTIR measurements of DNA, miRNA, and water solution samples under vacuum conditions;

FIG. 4A shows the measurements of hsa-DNA-3162-5p, hsa-DNA-1249-3p, hsa-DNA-6804-3p, hsa-DNA-let-7a-5p, and hsa-DNA-let-7d-5p for synthetic DNA samples;

FIG. 4B shows the measurements of hsa-miRNA-3162-5p, hsa-miRNA-1249-3p, hsa-miRNA-6804-3p, hsa-miRNA-let-7a-5p, and hsa-miRNA-let-7d-5p for synthetic miRNA samples;

FIG. 5A is a schematic diagram of a unit of the SEIRA sensor according to embodiments of the present disclosure;

FIG. 5B is an SEM image of the proposed SEIRA sensor in FIG. 5A;

FIG. 5C shows an electric field intensity distribution of the SEIRA sensor of FIG. 5B at 1379 cm⁻¹;

FIG. 5D shows the electric field intensity distribution of the SEIRA sensor of FIG. 5B at 3281 cm⁻¹;

FIG. 5E shows the reflectance of samples of miRNA and synthetic DNA, and of the SEIRA sensor for detecting the reflectance of the miRNA and DNA;

FIG. 6A shows simulation results for variations in the width of a selected nanorod of a SEIRA structure;

FIG. 6B shows simulation results for variations in the height of a selected nanorod of a SEIRA structure;

FIG. 7 illustrates a measurement phase of a method of biomarker detection according to various embodiments of the present disclosure;

FIG. 8 illustrates a method according to various embodiments of the present disclosure;

FIG. 9A shows the reflectance measurements of a bare substrate area without SEIRA sensor;

FIG. 9B shows the reflectance of an area with SEIRA sensor;

FIG. 10 shows another correlation between hsa-miR-let-7a-5p SEIRA-AR values and RT-qPCR counts;

FIG. 11 shows another correlation between hsa-miR-let-7a-5p SEIRA-AR values and NGS counts; and

FIG. 12A shows the SEIRA-AR values plotted against RT-qPCR results for hsa-miR-451a;

FIG. 12B shows the SEIRA-AR values plotted against RT-qPCR results for hsa-miR-126-5p;

FIG. 12C shows the SEIRA-AR values plotted against RT-qPCR results for hsa-miR-195-5p; and

FIG. 13 is a schematic diagram showing various aspects of the present disclosure, including a device and method for biomarker detection using surface-enhanced infrared spectroscopy.

### DETAILED DESCRIPTION

The following detailed description is made with reference to the accompanying drawings, showing details and embodiments of the present disclosure for the purposes of illustration. Features that are described in the context of an embodiment may correspondingly be applicable to the same or similar features in the other embodiments, even if not explicitly described in these other embodiments. Additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance as generally understood in the relevant technical field, e.g., within 10% of the specified value.

As used herein, the term “and/or” includes any and all combinations of one or more of the associated listed items.

The word “exemplary” is used herein to mean “serving as an example, instance, or illustration.” Any embodiment described herein as “exemplary” is not necessarily to be construed as preferred or advantageous over other embodiments. As used herein, the singular ‘a’ and ‘an’ may be construed as including the plural “one or more” unless apparent from the context to be otherwise.

Terms such as “first” and “second” are used in the description and claims only for the sake of brevity and clarity, and do not necessarily imply a priority or order, unless required by the context. The terms “about” and “approximately” as applied to a stated numeric value encompasses the exact value and a reasonable variance as will be understood by one of ordinary skill in the art, and the terms “generally” and “substantially” are to be understood in a comparable manner, unless otherwise specified.

Some methods may be described in terms of steps merely to aid understanding and/or for convenient reference. The delineation between one step and another step may be merely for convenient reference in the present disclosure. It will be understood that in actual implementation there may not be a clear division or transition from one step to another subsequent step. There may be a certain amount of overlap among the steps and/or more than one step may occur or be performed concurrently in time, etc.

### Biomarkers

Various blood-based biomarkers have been reviewed for the early detection of breast cancer. Circulating microRNAs (miRNAs) have emerged as a promising non-invasive biomarker for cancer diagnosis and prognosis because of their remarkable stability in the blood-stream and their involvement in cancer development and progression. They are a class of small non-coding RNAs with 19 to 25 nucleotides that play important roles in regulating gene expression. Conventional methods such as northern blotting, microarray-based hybridization, quantitative reverse transcription polymerase chain reaction (RT-qPCR), and next-generation sequencing (NGS) have been widely used to detect miRNAs. However, some of these methods are costly, and they involve complex and time-consuming procedures.

### Surface-Enhanced Infrared Absorption

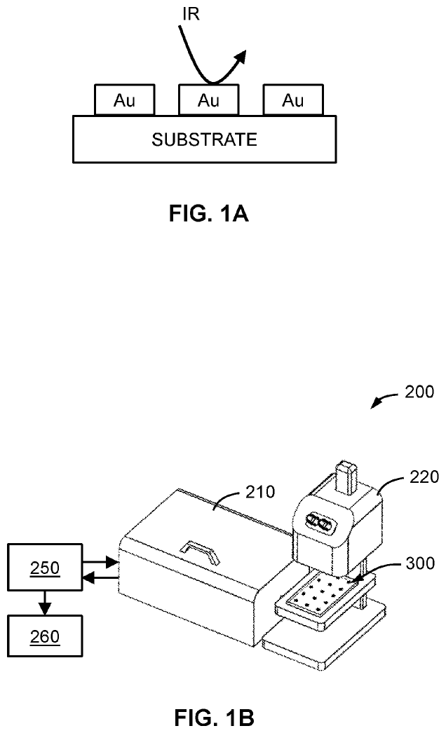

The present disclosure proposes an alternative label-free approach based on surface-enhanced infrared absorption (SEIRA). FIG. 1A is a schematic diagram showing a side view of an example of SEIRA sensor (also referred to as SEIRA structures) and infrared interaction thereat. The SEIRA technique detects the molecular vibrations that result in a change of the dipole moment of the molecules, and it measures the absolute frequency (molecular fingerprints) where the molecules absorb infrared light. For example, the metallic metasurface nanostructures at the substrate surface may be configured to exhibit resonance at the frequency where the molecules interact with the incident infrared light to improve the sensitivity of the infrared spectroscopy measurements. In the example of FIG. 1A, infrared light is shown interacting with The SEIRA sensor including a calcium fluoride (CaF₂) substrate and gold (Au) nanorods. Other materials may be used for the substrate and nanostructures.

### System

FIG. 1B illustrates a system 200 including an FTIR (Fourier transform infrared) module 210 attached with a microscope accessory or an attenuated total reflection (ATR) accessory 220 under vacuum conditions (e.g., Vertex 80v or Vertex 70v with Hyperion 2000, available from Bruker Corporation). The ATR accessory may be used for improving the measurement sensitivity of the FTIR instrument. The sensor chip 300 of the present disclosure may be placed on the sample stage. A reflective microscope objective (e.g., 15 times magnification) may be used to focus the incident light onto the SEIRA sensor (of the sensor chip 300) and collect the reflected signals. In some cases, the output signals from the FTIR module 210 are fed to a computer or a processor 250 configured to execute instructions stored in a computer-readable memory. The processor 250 may be configured to perform data analysis based on the output signals and provide a result 260 useful in the diagnosis of a medical condition such as but not limited to breast cancer.

### Sensor Chip

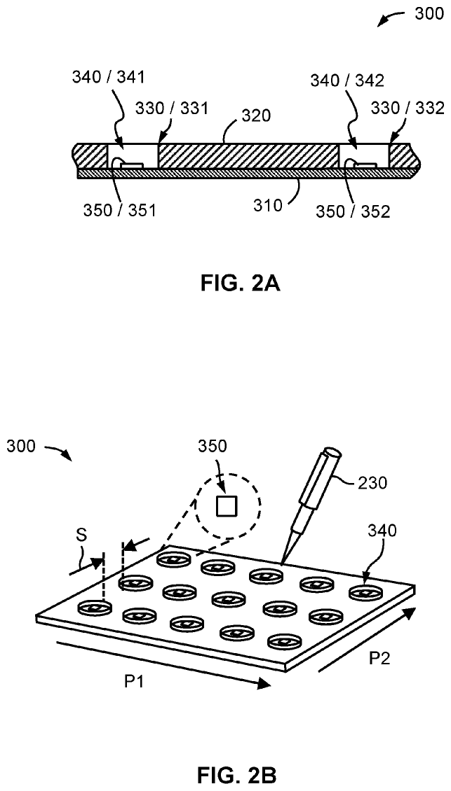

Embodiments of the proposed sensor chip 300 (also referred to as the device 300) include but are not limited to the examples illustrated in FIG. 2A and FIG. 2B.

FIG. 2A is a schematic cross-sectional view of a part of the proposed sensor chip 300. In this example, the sensor chip 300 includes a plurality of SEIRA sensors 350 disposed on a substrate 310. The sensor chip 300 includes a plurality of wells 340. A SEIRA sensor 350 is disposed in each well 340. In this example, every one of the plurality of wells 340 includes similarly configured SEIRA sensors 350.

In one sensor chip 300, each of the plurality of wells is isolated or separated from any other of the plurality of wells. For example, as shown in FIG. 2A, a first well 341 and a second well 342 are isolated from one another. In this example, it can be seen that the divider 320 forms a physical barrier or a wall between adjacent or immediately neighboring wells 340. The well 340 may include an open top end to receive samples for testing, otherwise each well 340 is fluidically isolated from any other well 340 in the sensor chip 300.

In some examples, the sensor chip 300 includes a substrate 310 and a divider 320 (or physical barrier) circumscribing/defining a well 340. A plurality of SEIRA sensors 350 are formed on a substrate 310. The divider 320 is formed with holes 330 (e.g., also referred to as “through holes”). The divider 320 and the substrate 310 are assembled together with the holes 330 aligned with the SEIRA sensors 350. For example, a first hole 331 may be positioned in alignment with the first SEIRA sensor 351, and a second hole 332 may be positioned in alignment with the second SEIRA sensor 352, such that the SEIRA sensors 350 are disposed in respective wells 340.

The sensor chip 300 may be formed with various numbers of wells, in which one or more of the wells include SEIRA sensors. Preferably, the sensor chip 300 includes multiple wells 340 with a corresponding plurality of SEIRA sensors disposed in respective ones of the wells 340. In one example, as illustrated in FIG. 2B, the sensor chip 300 may be configured as a multi-well sensor chip with a plurality of wells 340 arranged in a 5×3 array, e.g., five rows and three columns for a total of 15 individual wells 340. In other examples, the sensor chip 300 may include a 4×4 array of wells 340.

The spacing (S) between the wells 340 may vary from one sensor chip 300 to another. In some examples, the spacing between the wells 340 is greater than the diameter or size of the wells 340. In some examples, wells 340 are spaced apart from one another by a spacing that is at least three to four times the diameter of each well 340. To give an idea of the scale in some exemplary cases, and not to be limiting, immediately neighboring wells 340 may be spaced apart by a spacing in a range from about 0.5 cm to about 5.0 cm. The spacing between the wells 340 provides a separation of the solutions in each well 340, e.g., the spacing between the wells 340 is large enough so that the solution in one well 340 will not cross over to any of its neighboring wells. The size and/or shape of each well 340 may be varied from one sensor chip to another, e.g., the size and or shape of each well may be selected to provide a reasonable sample area for the collection of SERIA reflectance signals.

As used herein, the term “well” refers to a cavity or a concave region suitable for receiving a volume of a fluid sample to be tested. The fluid samples to be tested may include but are not limited to serum samples, serum-derived samples, and other tissue samples. The wells 340 of the proposed sensor chip 300 are not limited to the shapes or proportions illustrated in the appended figures. The wells 340 of the proposed sensor chip 300 may be separated from one another by one or more divider or wall-like features.

The sensor chip 300 allows detection at multiple sites (corresponding to multiple wells 340) to be performed independently and simultaneously for different parameters (e.g., P1, P2, etc.). For example, in some experiments, a micropipette 230 was used to dispense sample solutions from the same patient precisely in each well 340 in the same row. In the experiment, a different type of biomarker was provided in each column of wells. For one of the experiments, the rows measure different patients (i.e., Patient Sample 1 to 5) and the columns measure different target miRNA types (i.e., miRNA 1-3). It was experimentally demonstrated that the samples of five subjects could be accurately tested for three biomarkers at any one time using the same sensor chip.

In some embodiments, the proposed sensor chip 300 can be integrated with multiplexed detection. In one example, the sensor chip 300 includes 15 micro-size wells 340 capable of measuring multiple biomarkers and patient samples on a single platform. The SEIRA sensors 350 are repeated in each well 340, and each well 340 is isolated from its neighbors so that it can be treated as a separate SEIRA measurement site. The measurements at multiple wells (each well providing a different biomarker test) can then be multiplexed or collectively analyzed (e.g., via the processor 250) to output a diagnostic result that takes into consideration the results from multiple tests.

In some examples, each well in a group of wells may serve as a separate SEIRA test site for a different biomarker. For example, the sensor chip 300 may include one or more groups of wells 340, in which each group includes six (or a multiple of six) wells 340 forming a six-miRNA panel for cancer diagnosis.

In other examples, a variety of biomarkers useful for identifying different types of medical conditions may be provided in one sensor chip, with each well including one type of biomarker. By simultaneously testing samples of the same subject in multiple wells, the collective result may be used to aid diagnosis of the subject's medical condition.

In yet other examples, the same biomarker may be provided in a plurality of wells in the sensor chip, and samples from multiple individuals may be simultaneously tested, e.g., for rapid screening of a large population.

### Fabrication of Prototype Sensor Chip

One prototype of the sensor chip 300 was fabricated by firstly forming SEIRA sensors 350 on a substrate 310. The SEIRA sensors were repeated 15 times, each with a dimension of 500 μm×500 μm and a center-to-center distance of 7.5 mm. Next, a multi-well mask was created by a polydimethylsiloxane (PDMS) layer of thickness 1 mm with the well positions aligned with the patterned SEIRA sensors. Each well was made by a pen puncher with a tip size of 1.5 mm. The PDMS layer was then placed on top of the SEIRA sensors and adhered to by van der Waals force.

In some applications, the sensor chip 300 may be formed by patterning a substrate 310 with the nanostructures 360 for multiple units 370 of the array, and overlaying a pre-formed plate to form an assembly. The pre-formed plate may be a substantially planar article with a plurality of through holes formed therein. The assembly is made with the SEIRA sensors 350 disposed in alignment with the through holes of the pre-formed plate, forming the wells 340. The pre-formed plate may be additively fabricated, molded, machined, or manufactured by other methods, using glass, polymer, or other suitable inert materials.

### SEIRA Sensors

The resonance wavelength(s) of the SEIRA sensors 350 (also referred to as “nanostructures”) of the proposed sensor chip 300 can be selected or tuned by configuring the material, shape, and size of the nanostructures. The SEIRA sensors proposed herein were experimentally validated to perform well for broadband testing. The following describes one exemplary method of configuring the SEIRA sensors for the purpose of the sensor chip 300. Other nanostructures, including zig-zag nanotips, nano-discs, nano-islands, etc., may alternatively be selected and sized/dimensioned in a similar manner so that the resonances of the nanostructures would coincide or overlap with the absorption fingerprint regions of the target biomarkers. In some examples, a machine learning module may be trained to suggest preferred one or more shapes for the nanostructures.

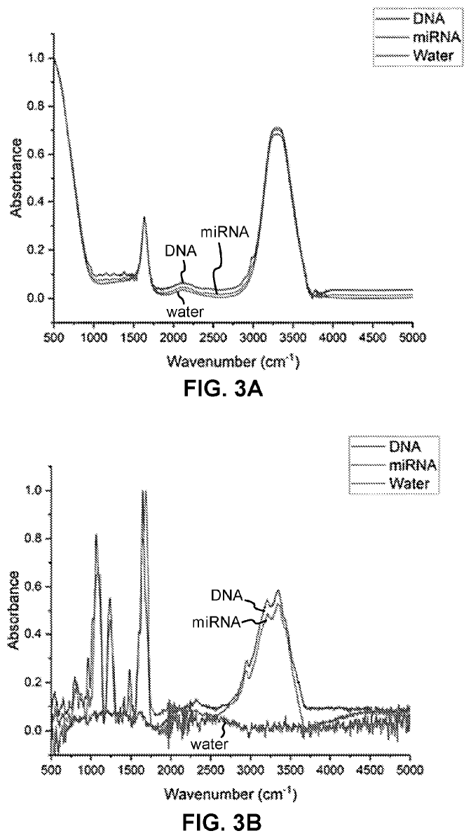

FIG. 3A shows the infrared spectrum obtained for samples of synthetic DNA, synthetic miRNA, and water respectively, e.g., by using a FTIR spectroscopy instrument with ATR (ATR-FTIR measurements) under atmospheric conditions. It would be apparent from FIG. 3A that the absorbance spectrum curves for DNA and miRNA are similar to one another.

FIG. 3B shows the ATR-FTIR measurements under vacuum conditions to remove interference from water. In FIG. 3B, the absorbance spectra for DNA and miRNA are again very similar to one another, but can now provide a visualization of the molecular fingerprints of the DNA and the miRNA. Each peak in the absorbance spectrum corresponds to a type of molecular vibration or a type of chemical bond. Table 1 shows exemplary peak wavenumbers corresponding to different types of chemical bonds.

TABLE 1
Exemplary Peak Wavenumbers

| Peak Wavenumber (cm⁻¹) | Chemical Bond |
|---|---|
| 788 | Free Cytosine Vibration |
| 798 | Free Adenine Vibration |
| 813, 866 | Main N-type Sugar Marker |
| 966 | Ribose Ring Vibration |
| 995 | C-C and C-O Ribose Stretching |
| 1082 | PO2 Symmetric Stretching |
| 1110 | C-O Ribose Ring Stretching |
| 1240 | PO2 Anti-Symmetric Stretching |
| 1475 | Adenine and Guanine Ring Vibration |
| 1492 | Cytosine in-plane Vibration |
| 1600 | C=N Ring Vibration of Guanine |
| 1650 | C2=02 Stretching in Cytosine |
| 1685 | C2=02 Stretching in Guanine |
| 2950 | C=H Stretching |
| 3210 | O-H Stretching |
| 3340 | N-H Stretching |
| 3140 | O-H Stretching |
| 3330 | N-H Stretching |

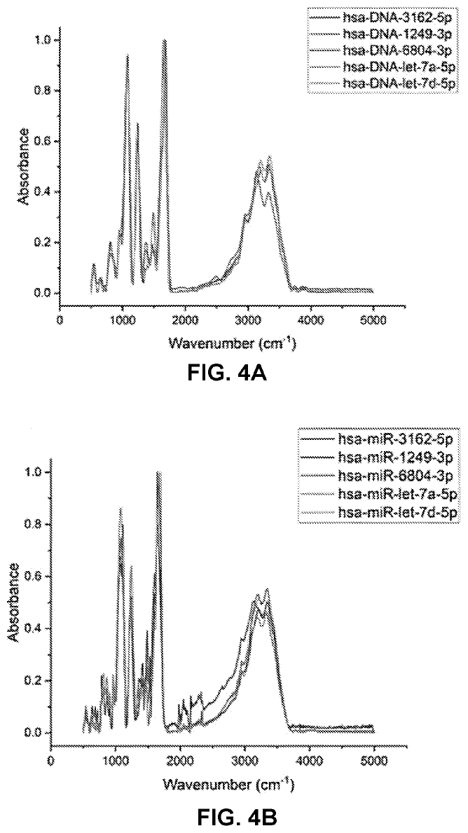

FIG. 4A and FIG. 4B show the absorbance spectra for various examples of synthetic DNA and synthetic miRNA (available from Integrated DNA Technologies, Inc.) respectively, measured under a vacuum condition. More specifically, FIG. 4A shows the measurements of hsa-3162-5p, hsa-1249-3p, hsa-DNA-6804-3p, hsa-let-7a-5p, and hsa-let-7d-5p for synthetic DNA samples, and FIG. 4B shows the measurements of hsa-3162-5p, hsa-1249-3p, hsa-DNA-6804-3p, hsa-let-7a-5p, and hsa-let-7d-5p for synthetic miRNA samples. It was found that although there are slight variations in the spectra of the of different kinds of DNA and miRNA samples, two prominent fingerprint regions can be defined, e.g., one fingerprint region of 800 to 2000 cm⁻¹ and another fingerprint region of 2800 to 3500 cm⁻¹. In other words, based on the absorbance spectra of the DNA and miRNA to be used, multiple fingerprint regions (bands of wavelengths with one or more peaks in each band) may be identified. Preferably, two fingerprint regions are defined based on FTIR spectra obtained under vacuum conditions.

According to various embodiments of the present disclosure, the sensor chip 300 includes SEIRA sensors 350 shaped and sized to exhibit resonance at multiple resonance wavenumbers corresponding to the multiple fingerprint regions of interest. For example, the SEIRA sensors 350 may include one or more metallic nanorods 360 that are collectively characterized by resonance peaks that coincide with the respective centers of the fingerprint regions of interest. Operable dimensions, or preferred dimensions, for each of the nanostructures 360 (e.g., nanorods in this example) may be determined with the aid of simulation (e.g., Lumerical FDTD software (available from Ansys, Inc.).

The SEIRA sensor 350 may be described as a plurality of units 370 in an array, in which each unit 370 includes a first nanorod 361 and a second nanorod 362 of different dimensions so as to provide resonance at different wavenumbers.

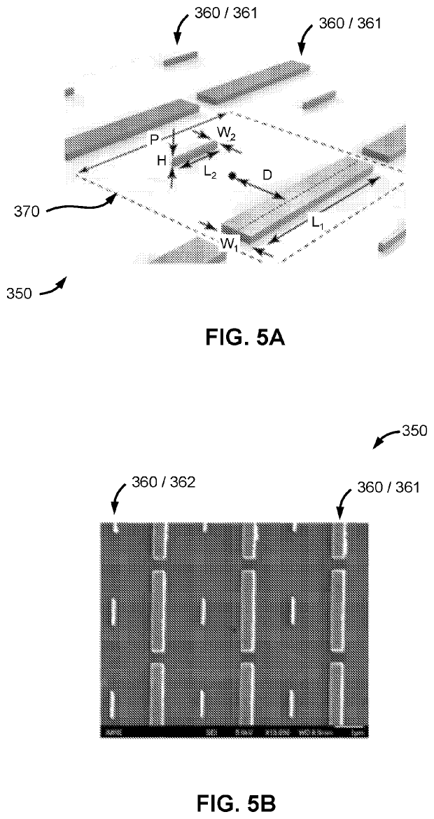

FIG. 5A schematically shows an example of a unit 370 of SEIRA structures with a longer and wider nanorod (first nanorod 361) and a shorter and narrower nanorod (second nanorod 362). The unit 370 repeats in a period P of 3 μm or about 3 μm. The spacing between the two nanorods 360 (i.e., between the first nanorod 361 and the second nanorod 362 of a unit 370) is 2D or 1.5 μm. The length, width, and height of the longer and wider nanorod (first nanorod 361) are: L1=2.6 μm, W1=0.4 μm, H1=H=0.1 μm. The length, width, and height of the shorter and narrower nanorod (second nanorod 362) are: L2=0.85 μm, W2=0.08 μm, H2=H=0.1 μm. The dimensions of the nanorods 360 may vary from one example to another, i.e., the dimensions given are solely to illustrate. Based on the teachings provided herein, one of ordinary skill in the art will be able to modify the dimensions without inventive input.

The SEIRA sensors 350 may be provided on a device or a sensor chip 300 suitable for use with a scanning electron microscope, as shown in the SEM image of FIG. 5B. The SEIRA sensors 350 may be disposed in a lattice array, e.g., in a square lattice array, a hexagonal lattice array, etc.

The electric field intensity distributions of the SEIRA sensors 350 may be simulated. As shown in FIG. 5C and FIG. 5D, the SEIRA sensor 350 in a well 340 showed two resonance peaks at 1379 cm-1 and 3281 cm⁻¹, respectively. Specifically, the first nanorod 361 was configured to have a resonance at 1379 cm⁻¹ with an intensity enhancement of 1.4×103 times at the edges of the first nanorods. The second nanorod 362 was configured to have a resonance at 3281 cm⁻¹ with an intensity enhancement of more than 8×10³ times at the edges of the second nanorods. The resonance peaks and widths can be tuned by changing the length, width, and height of the nanorods. For example, an increase in the width will increase the wavenumber of the resonance peak and width.

The final optimized result of the SEIRA sensor 350 is shown in FIG. 5E as a reflectance spectrum (of the SEIRA structures) characterized by two fingerprint regions 400 (e.g., a first fingerprint region 401 and a second fingerprint region 402). The SEIRA sensor 350 is characterized by a more sensitive response at similar resonant wavenumbers as the DNA (e.g., DNA reflectance spectrum 411) and the miRNA (e.g., the miRNA reflectance spectrum 412).

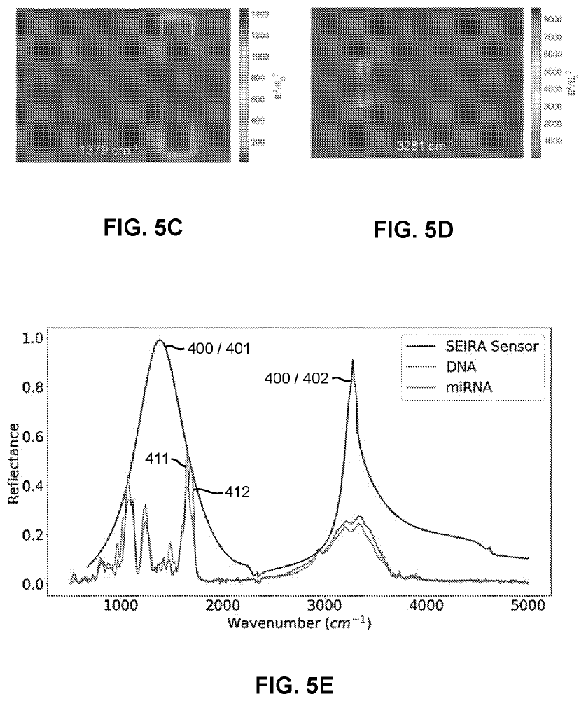

FIG. 6A shows additional simulation results for variations in the “W₂” dimension, in which the “W₂” dimension refers to the width of the second nanorod 362 (e.g., see FIG. 5A). FIG. 6B shows simulation results for variations in a “h” dimension, in which the “h” dimension refers to a height of the first nanorod 361 or the second nanorod 362. By tuning the dimensions of the nanorods 360, a reflectance spectrum with two fingerprint regions with the desired amplified resonances may be obtained.

The SEIRA sensor 350 or SEIRA nanostructures 360 may be patterned by electron beam lithography (e.g., ELS-7000 available from Elionix Inc.) according to the dimensions determined from simulations as above. In one experiment, two layers of photoresists were spin-coated (PMMA 495 A3, 1:1 with IPA, 4000 rpm 90 seconds and hot plate cured at 180° C. for 10 minutes, followed by PMMA 950 A5, 1:2 with IPA, 4000 rpm 90 seconds and hot plate cured at 180° C. for 10 minutes) on a clean CaF₂ substrate. The electron beam current setting was 500 pA, 100 kV, and dosage 0.6. After the electron beam expo-sure, the sample was dipped into MIBK:IPA 1:3 solution for 1 minute, followed by rinsing and N₂ air gun drying. Electron beam evaporation (e.g., Explorer available from Denton Vacuum) was performed subsequently to deposit 10 nm of Cr adhesion layer and 100 nm of Au layer. A lift-off process was then carried out using acetone solution to remove the extra film of PMMA, followed by washing in the IPA solution and DI water and then drying.

The sensor chip 300 fabricated as described in the examples above may be described as multi-well SEIRA sensor chip with metallic nanorod SEIRA structures enabling a broadband multiband resonance. The SEIRA sensor is configured so that the resonances coincide with the absorption fingerprint regions of the target miRNA biomarkers to enable maximizing or amplification of the SEIRA signals.

### Method

In one experiment, a region of interest of 100 μm×100 μm on the SEIRA sensor 350 in a well 340 was selected for each measurement. Three measurements were performed at different locations for each SERIA sensor 350 to minimize the effect of fabrication non-uniformity and ensure measurement repeatability. Each FTIR measurement was taken at the wavenumber range of 800 to 5000 cm⁻¹ with a resolution of 4 cm⁻¹ and 64 scans.

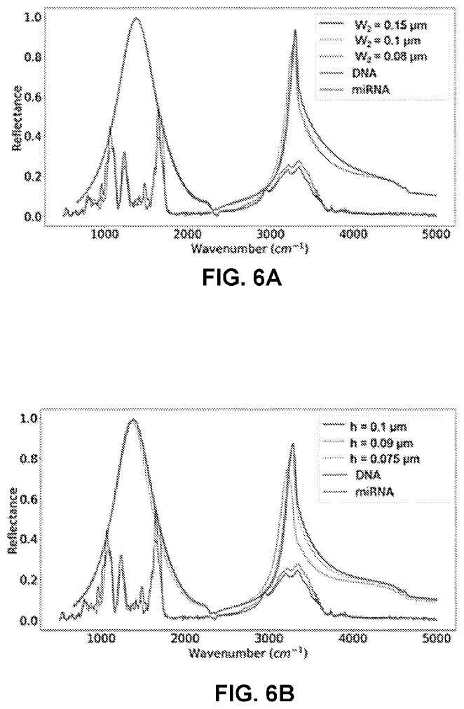

According to one embodiment of the present disclosure, a method 500 of testing a sample and/or biomarker detection includes a measurement phase 510. The measurement phase 510 includes a step of collecting FTIR signals from a clean SEIRA substrate (e.g., step 511 of FIG. 7).

Next, solutions containing complementary ssDNA molecules (2 μL, 50 μM) to the target miR-NA molecules with a thiol group modification were immobilized to the SEIRA substrate (e.g., step 512 of FIG. 7). The thiol group will react to Au so that the ssDNA molecules will bind to the SEIRA substrate. After 1 hour, the substrate was rinsed thoroughly with RNase-free water to remove the excess non-binded ssDNA molecules. FTIR measurements were taken of the DNA-bound SEIRA substrate (SEIRA-DNA) as illustrated, for example, at step 513 of FIG. 7.

Next, solutions containing target miRNA molecules (2 μL) extracted from breast cancer patients' serums were immobilized on the SEIRA-DNA substrate (e.g., step 514 of FIG. 7). Only target miRNA molecules will bind to the ssDNA molecules because of the peptide bonds. After 1 hour, the sensor chip 300 was rinsed thoroughly with RNase-free water to remove the excess non-binded miRNA molecules. FTIR measurements were taken of the miRNA-DNA-bound SEIRA substrate (SEIRA-DNA-miRNA) as illustrated, for example, at step 515 of FIG. 7.

FTIR microscope measurements were taken at each step, i.e., SEIRA, SEIRA-DNA, and SEIRA-DNA-miRNA. In the experiment, the same workflow was applied to each well on the sensor chip 300.

### Data Analysis Workflow

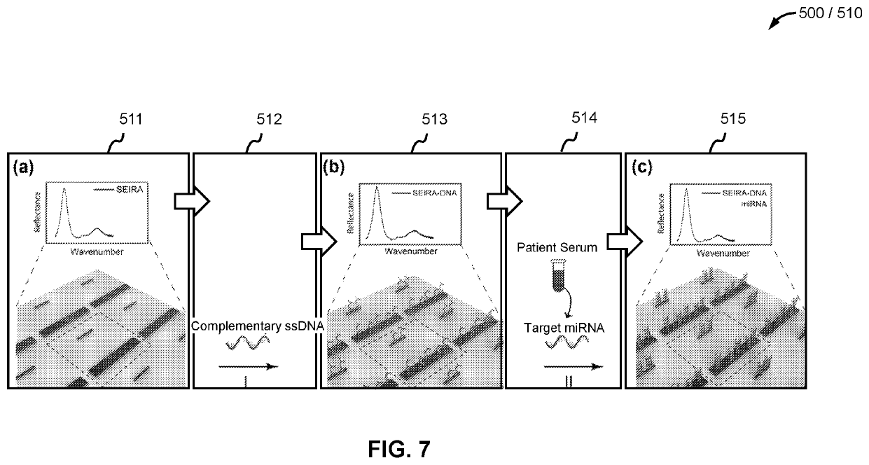

According to various embodiments of the present disclosure, the proposed method 500 further includes a data analysis phase 520 involving calculating the area under the curve of the difference spectrum, as shown in FIG. 8.

Firstly, in the measurement phase 510, the reflectance spectrum of SEIRA(R_{SEIRA}(λ)), SEIRA-DNA(R_{SEIRA-DNA}(λ)), and SEIRA-DNA-miRNA(R_{SEIRA-DNA-miRNA}(λ)) were measured at each of the stages. In some examples, the measurements may be taken multiple times (e.g., three times) at different locations.

Optionally, pre-processing 530 may then be carried out, including but not limited to baseline correction and/or Savitzky-Golay smoothing.

Data processing 540 of the method 500 involve: (i) calculation of the differences between the two spectra:

$${Δ}_{DNA} ( λ ) = {R}_{SEIRA - DNA} ( λ ) - {R}_{SEIRA} ( λ ) ; \qquad ( 1 )$$

$$and$$

$${Δ}_{miRNA} ( λ ) = {R}_{SEIRA - DNA - miRNA} ( λ ) - {R}_{SEIRA - DNA} ( λ ) . \qquad ( 2 )$$

Data processing 540 of the method 500 may further involve: (ii) calculation of the area under the curves:

$${A}_{DNA} = \int {Δ}_{DNA} ( λ ) d λ ; \qquad ( 3 )$$

$$and$$

$${A}_{miRNA} = \int {Δ}_{miRNA} ( λ ) d λ . \qquad ( 4 )$$

Data processing 540 of the method 500 may further involve: (iii) calculation of the ratio between the two areas:

$$Ratio = \vert {A}_{miRNA} / {A}_{DNA} \vert . \qquad ( 5 )$$

For the sake of brevity, the proposed method 500 may also be referred to as a method to obtain the new indicator herein referred to as “SEIRA-AR” Index or “SEIRA Area Ratio”.

The SEIRA-AR value or SEIRA-AR Index may be calculated for each target miRNA type. The ratio between the two areas under the curve represents the miRNA-DNA binding events as a percentage of the DNA-SEIRA binding events so that unsuccessful DNA binding events are not reflected. This structure and analysis method 500 accounts for both the shift in the peak position and the change in the intensity values across the entire spectrum. The method 500 allows the total change in the optical signals due to the DNA and miRNA binding events to be captured accurately.

A linear correlation 550 may be established between the SEIRA-AR Indices and the corresponding RT-qPCR and NGS read counts to validate the method. The expression levels of miRNAs used in this study were previously analyzed by RT-qPCR and NGS.

### SEIRA Enhancement

An experiment was carried out to quantify the SEIRA enhancement by comparing the signal strength of a bare area (without SEIRA structures) and with the SEIRA structures as proposed herein.

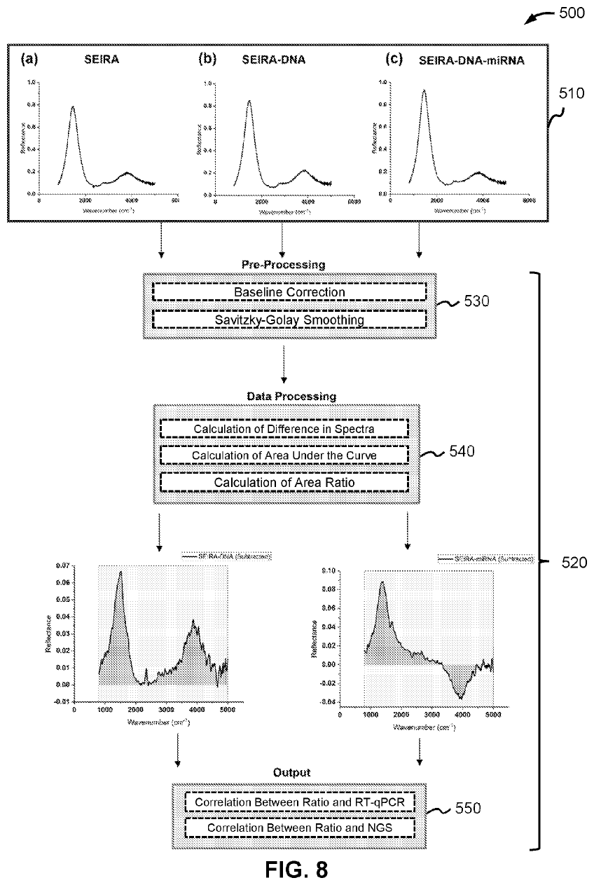

FIG. 9A shows the reflectance measurements of a bare substrate area without SEIRA nanostructures 360 and FIG. 9B shows the reflectance of an area with SEIRA nanostructures 360. The reflectance with SEIRA nanostructures 360 was enhanced 20 times compared to a bare area. The biological reaction after each step, SEIRA, SEIRA-DNA, and SEIRA-DNA-miRNA was clearly captured in the optical measurements, which involves changes in the reflectance spectrum over the entire wavenumber range, not only a shift in the peak position.

hsa-miR-let-7a-5p

Firstly, the SEIRA-AR analysis method was compared with established miRNA detection methods. In this study, hsa-miR-let-7a-5p was used as a miRNA target to investigate the detection capability of the SEIRA sensor. Five patients (three malignant “M” and two benign “B”) were measured. Their hsa-miR-let-7a-5p SEIRA-AR values were calculated and plotted against the RT-qPCR and NGS read counts. The mean values and the standard deviations were shown in blue circles and error bars. A linear curve fitting was performed with an equation y=a×x, with a being the fitting parameter. The constraint that the curve intercepts at the origin reflects the physical meaning that when the read count is zero, the SEIRA-AR value should be zero. The fitting parameters are a=6.60×10⁻⁵ for RT-qPCR and a=5.10×10⁻⁵ for NGS.

Pearson's r, also known as Pearson's correlation coefficient, measures the strength of the linear relationship. A value closer to 1 indicates a strong positive linear correlation between the paired data. R Squared value, also known as the coefficient of determination, measures the quality of the linear relationship. A value closer to 1 indicates a better-fitted line that explains the variability of the response variable. It is seen that Pearson's r and R Squared values are 0.90 and 0.81 in both cases, indicating that a strong and good linear relationship was established between SEIRA-AR values and RT-qPCR and NGS values.

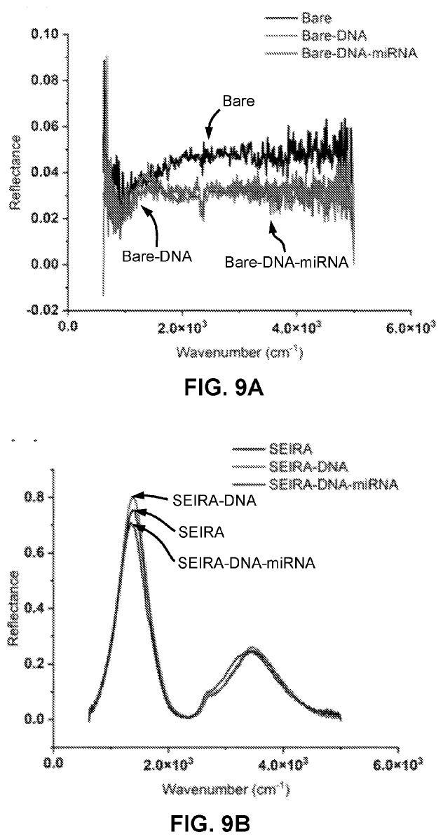

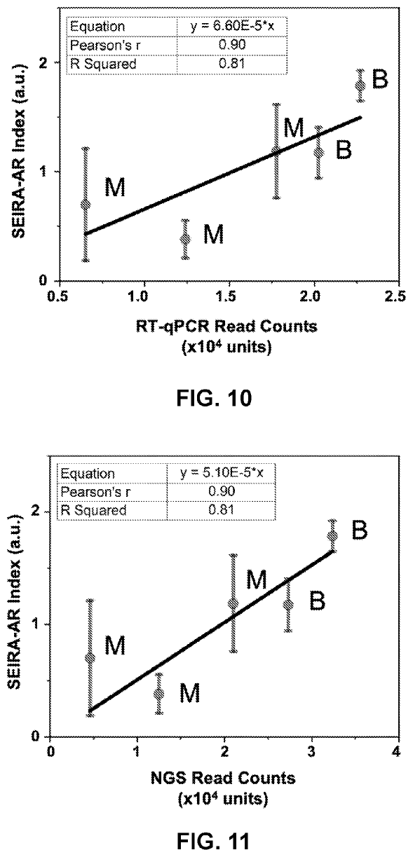

In another set of experiments, relatively consistent results were obtained. As shown in FIG. 10 and FIG. 11, the fitting parameters obtained were a=6.44×10⁻⁵ for RT-qPCR and a=5.04×10⁻⁵ for NGS, respectively.

hsa-miR-451a, hsa-miR-126-5p, and hsa-miR-195-5p

In another experiment, breast cancer miRNA biomarkers were measured. Three miRNAs were selected for detection, namely, hsa-miR-451a, hsa-miR-126-5p, and hsa-miR-195-5p. Hsa-miR-451a predicts the therapeutic benefit of trastuzumab for HER2-positive metastatic breast cancer patients. Hsa-miR-195-5p is used as a detection and therapeutic target for breast cancer. Hsa-miR-126-5p has shown expression reduction in triple-negative breast cancer tissues compared to normal breast cancer tissues. Measurements were taken of samples from five patients (Three malignant “M” and two benign “B”).

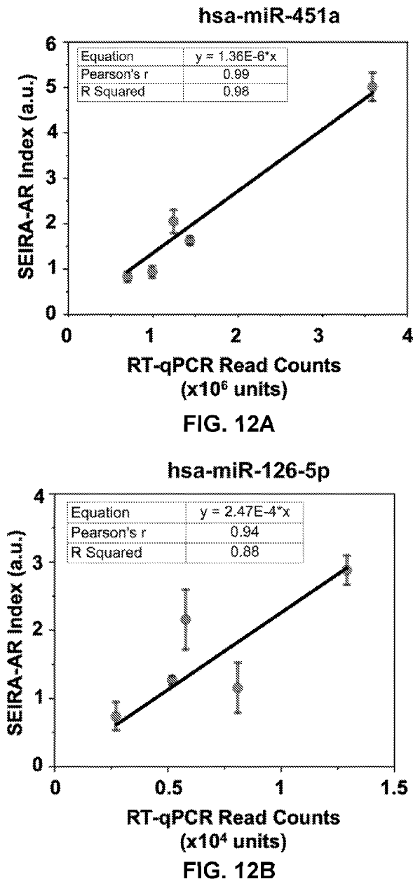

The SEIRA-AR Indices or values obtained were plotted against RT-qPCR results, as shown in FIG. 12A to FIG. 12C. A linear correlation was established for each miRNA biomarker, i.e., y=1.36×10⁻⁶x (for hsa-miR-451a), y=2.47×10⁻⁴x (for hsa-miR-126-5p), and y=1.00×10⁻²x (for hsa-miR-195-5p). The Pearson's r values are 0.99, 0.94, 0.93, and R Squared values are 0.98, 0.88, 0.86, respectively, which indicate good correlations. This shows that the SEIRA sensor and the SEIRA-AR analysis method are capable of multiplexed measuring of biomarker molecules of clinical samples accurately.

The various examples described in the foregoing illustrate the suitability and benefits of the proposed method 500 and sensor chip 300 for providing a less-invasive, quick, and reliable test to discriminate breast cancers and non-breast cancers in women with abnormal screening mammograms.

In the proposed method 500 of biosensing and device for biosensing, the nanorods (or nano-antennas) exhibit a broadband multi-resonance feature with the resonance wavelengths capable of matching the absorption regions of the target biomolecules in the mid-infrared wavelength region. The absorption spectrum of the target biomolecules is measured by attenuated total reflection FTIR (ATR-FTIR) under vacuum conditions.

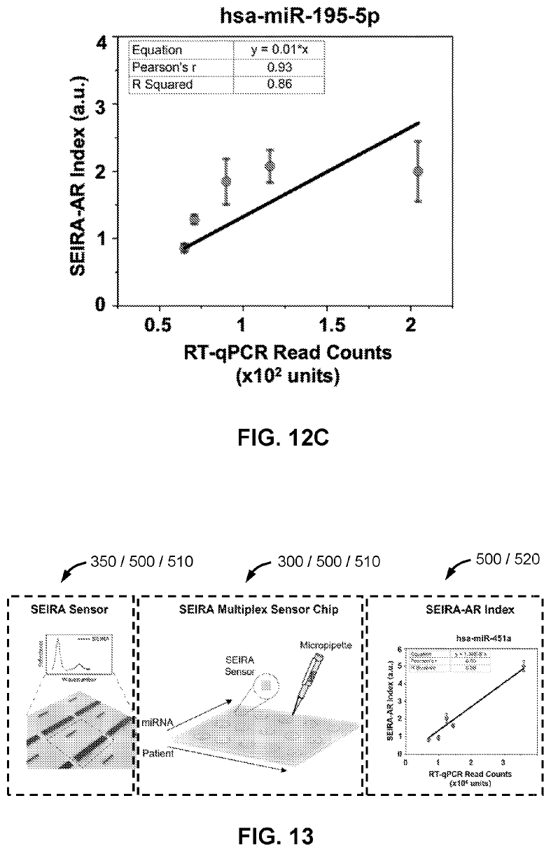

FIG. 13 is schematic diagram showing various aspects of the present disclosure, including a device 300 and method 500 for biomarker detection using surface-enhanced infrared spectroscopy. The device 300 includes a SEIRA sensor which may be provided in the form of a SEIRA multiplex sensor chip. The method 500 may include a measurement phase 510 using the device 300. The method 500 may include a data analysis phase 520. The resulting SEIRA-AR Index obtained may be used to provide a more accurate detection of biomarkers and fewer instances of false-positive results.

In one aspect, the method 500 of testing a sample includes: acquiring a first Fourier transform infrared (FTIR) spectrum from a surface-enhanced infrared absorption (SEIRA) sensor; acquiring a second Fourier transform infrared (FTIR) spectrum from a surface-enhanced infrared absorption (SEIRA) sensor bound with a molecule complementary to a target molecule; acquiring a third FTIR spectrum from the SEIRA sensor after providing the sample to the SEIRA sensor; determining a first change from the first FTIR spectrum to the second FTIR spectrum; determining a second change from the second FTIR spectrum to the third FTIR spectrum; and based on the first change and the second change, determining a presence and/or a concentration of a target molecule in the sample, wherein each of the first change and the second change includes a change in intensity across a range of frequencies.

The determining of the presence and/or the concentration of the target molecule in the sample may include determining an area ratio, in which the area ratio is a ratio between the area under the first change and the area under the second change, and in which the area ratio is indicative of a concentration of the target molecule in the sample.

The determining of the presence and/or the concentration of the target molecule in the sample may include a shift in one or more resonance peak frequencies from the first FTIR spectrum to the second and third FTIR spectrum.

The second FTIR spectrum may correspond to a first binding event between the complementary molecule and metallic elements of the SEIRA sensor.

The third FTIR spectrum may correspond to a target binding event between the target molecule and the first molecule bound to the SEIRA sensor.

The method may further include acquiring each of the first FTIR spectrum, the second FTIR spectrum, and the third FTIR spectrum by measuring a respective reflection spectrum using a microscopic FTIR spectrometer.

The method may further include: binding one or more first molecules to nano-antennas of the SEIRA sensor, each of the one or more first molecules being selected from complementary molecules of at least one of a plurality of the target molecules.

The method may further include: determining a concentration of each of the plurality of the target molecules based on the respective area ratio obtained from one acquisition of the second FTIR spectrum and third FTIR spectrum.

The target molecule may be one or more biomarkers.

The first molecule may be a single-stranded deoxyribonucleic acid (ssDNA) molecule, in which the target molecule is a micro ribonucleic acid (miRNA) molecule or another ssDNA molecule.

The area ratio may be linearly correlatable to any one or both of a reverse transcription-polymerase chain reaction (RT-qPCR) test result and a next-generation sequencing (NGS) test result.

In another aspect, a device (sensor chip 300) for testing a sample, including: a plurality of wells, each of the plurality of wells being at least partially circumscribed by a physical barrier to prevent fluidic communication through the physical barrier between the adjacent ones of the plurality of wells. The device includes a surface-enhanced infrared absorption (SEIRA) sensor disposed in each of the plurality of wells, in which the SEIRA sensor is configured with a resonant response in a plurality of resonant peak frequencies distributed over a range of frequencies.

The SEIRA sensor includes: a substrate; and multiple pairs of nano-antennas disposed on the substrate in a lattice array, in which any one of the multiple pairs of nano-antennas include: a shorter nano-antenna; and a longer nano-antenna, wherein the shorter nano-antenna and the longer nano-antenna are in alignment along an axis of symmetry bisecting one of the multiple pairs of nano-antennas.

Each of the multiple pairs of nano-antennas may be dimensionally configured to exhibit a broadband multi-resonance with various resonance wavelengths.

The nano-antennas may be dimensionally configured to exhibit a plurality of resonances matching respective absorption regions characteristic of one or more target molecules in the sample.

The dimensions of the nano-antennas may be determined to produce resonance wavelengths matching characteristic fingerprints of one or more target molecules obtained by the attenuated total reflection FTIR under vacuum condition.

The lattice array may be characterized by a period of 3 μm, in which the shorter nano-antenna is characterized by a length of 0.8 micrometers (μm), a width of 0.08 μm, and a height of 0.1 μm, and in which the longer nano-antenna is characterized by a length of 2.6 μm, a width of 0.4 μm, and a height of 0.1 μm, and in which the shortest spacing between the shorter dipole and the longer dipole is 1.5 μm.

The substrate may be made of calcium difluoride (CaF₂) and the nano-antennas may be made of gold (Au).

A method of testing a sample using the device in which the sample includes a mixed solution of one or more target molecules and one or more non-target molecules. The method may include: simultaneously acquiring a first Fourier transform infrared (FTIR) spectrum for each of a first well and a second well, the first well and the second well being selected from the plurality of wells and having dimensionally similar SEIRA sensors patterned therein, each of the SEIRA sensors including multiple pairs of nano-antennas patterned in a lattice array; binding a first molecule to the multiple pairs of nano-antennas of the first well, the first molecule being complementary to a first target molecule; binding a second molecule to the multiple pairs of nano-antennas of the second well, the second molecule being complementary to a second target molecule; simultaneously acquiring a second Fourier transform infrared (FTIR) spectrum for each of the first well and the second well; providing the mixed solution to the first well and the second well; simultaneously acquiring a third FTIR spectrum for each of the first well and the second well; and simultaneously determining a presence and/or a concentration of the first target molecule and a presence and/or a concentration of the second target molecule.

The method may further include: determining a first area ratio based on the first FTIR spectrum of the first well, the second FTIR spectrum of the first well, and the third FTIR spectrum of the first well; and determining a second area ratio based on the first FTIR spectrum of the second well, the second FTIR spectrum of the second well, and the third FTIR spectrum of the second well, wherein the first area ratio and the second area ratio are indicative of respective concentrations of different target molecules in the mixed solution.

The sensor chip 300 includes multiple wells 340 with each well being isolated from one another. Each well contains metallic (e.g., Au) nano-antennas (metallic elements) disposed on a substrate (e.g., CaF₂), with the nano-antennas (SEIRA structures 350) being arranged in two overlapping arrays (or two types of nano-antennas in one array). One array of shorter nano-antennas and another array of longer nano-antennas, the lengths and widths of the dipoles are different to provide multi-band resonance. The shorter nano-antennas and the longer nano-antennas are aligned in a lateral direction (normal to the axial direction/length of the nano-antennas) (or in a square lattice).

The method 500 includes using a SEIRA structure in which the nanorods (or nano-antennas) exhibit a broadband multi-resonance feature with the resonance wavelengths in the mid-infrared wavelength region matching the absorption regions of the target biomolecules. The absorption spectrum of the target biomolecules is measured by attenuated total reflection FTIR (ATR-FTIR) under the vacuum condition. According to some embodiments, the method 500 when applied to biosensing includes: binding complementary ssDNA to the nano-antennas and collecting FTIR signals; collecting FTIR signals when target miRNA molecules selectively bind to the ssDNA; measuring the ratio of area under the curve of the FTIR spectra (the change in the area under the curve reflects the concentration of the ssDNA or the target miRNA molecules; and correlating the area ratio to RT-qPCR and NGS results.

The proposed SEIRA-AR method is more accurate than conventional SEIRA methods because the proposed SEIRA-AR method takes into consideration both the shift in the resonant frequency, and also the change in the resonant intensity by looking at the change in the area under the curve. That is, the sensor chip is configured to enable “broadband multi-resonance”, e.g., provide the functionality of using one configuration of the sensing structure or nano-antennas to concurrently/simultaneously detect multiple distinct resonance peaks across a range of frequencies.

The mechanism on detecting a target DNA or RNA molecule involves a two-step binding process with the first step including binding a complementary ssDNA to the SEIRA substrate, and a second and subsequent step of binding of the target molecule to the complementary ssDNA. This ensures the specificity of detecting target molecule only, not other molecules. A clinical sample would normally consist of a mixture of different types of DNA or RNAs. The SEIRA-AR method proposed herein has been validated by industry-standard RT-qPCR and NGS results which shows that it can detect a specific target miRNA molecule in a mixture RNA solution.

The proposed SEIRA sensor chip 300 and SEIRA-AR analysis method 500 as described in various embodiments herein are applicable to any two-step binding process in general, including but not limited to ssDNA/miRNA binding. The ssDNA/miRNA binding described above is merely provided as an example to aid understanding.

All examples described herein, whether of apparatus, methods, materials, or products, are presented for the purpose of illustration and to aid understanding, and are not intended to be limiting or exhaustive. Modifications may be made by one of ordinary skill in the art without departing from the scope of the claimed invention.

1. A method of testing a sample, comprising:
acquiring a first Fourier transform infrared (FTIR) spectrum from a surface-enhanced infrared absorption (SEIRA) sensor;
acquiring a second Fourier transform infrared (FTIR) spectrum from a surface-enhanced infrared absorption (SEIRA) sensor bound with a molecule complementary to a target molecule;
acquiring a third FTIR spectrum from the SEIRA sensor after providing the sample to the SEIRA sensor;
determining a first change from the first FTIR spectrum to the second FTIR spectrum;
determining a second change from the second FTIR spectrum to the third FTIR spectrum; and
based on the first change and the second change, determining a presence and/or a concentration of a target molecule in the sample, wherein each of the first change and the second change includes a change in intensity across a range of frequencies.

2. The method according to claim 1, wherein determining of the presence and/or the concentration of the target molecule in the sample comprises determining an area ratio, and wherein the area ratio is a ratio between the area under the first change and the area under the second change, and wherein the area ratio is indicative of a concentration of the target molecule in the sample.

3. The method according to claim 1, wherein determining the presence and/or the concentration of the target molecule in the sample comprises a shift in one or more resonance peak frequencies from the first FTIR spectrum to the second and third FTIR spectrum.

4. The method according to claim 1, wherein the second FTIR spectrum corresponds to a first binding event between the complementary molecule and metallic elements of the SEIRA sensor.

5. The method according to claim 1, wherein the third FTIR spectrum corresponds to a target binding event between the target molecule and the first molecule bound to the SEIRA sensor.

6. The method according to claim 1, comprising: acquiring each of the first FTIR spectrum, the second FTIR spectrum, and the third FTIR spectrum by measuring a respective reflection spectrum using a microscopic FTIR spectrometer.

7. The method according to claim 1, comprising: binding one or more first molecules to nano-antennas of the SEIRA sensor, each of the one or more first molecules being selected from complementary molecules of at least one of a plurality of the target molecules.

8. The method according to claim 7, comprising: determining a concentration of each of the plurality of the target molecules based on the respective area ratio obtained from one acquisition of the second FTIR spectrum and third FTIR spectrum.

9. The method according to claim 1, wherein the target molecule is one or more biomarkers.

10. The method according to claim 1, wherein the first molecule is a single-stranded deoxyribonucleic acid (ssDNA) molecule, and wherein the target molecule is a micro ribonucleic acid (miRNA) molecule or another ssDNA molecule.

11. The method according to claim 2, wherein the area ratio is linearly correlatable to any one or both of a reverse transcription-polymerase chain reaction (RT-qPCR) test result and a next-generation sequencing (NGS) test result.

12. A device for testing a sample, comprising:
a plurality of wells, each of the plurality of wells being at least partially circumscribed by a physical barrier to prevent fluidic communication through the physical barrier between the adjacent ones of the plurality of wells; and
a surface-enhanced infrared absorption (SEIRA) sensor disposed in each of the plurality of wells, wherein the SEIRA sensor is configured with a resonant response in a plurality of resonant peak frequencies distributed over a range of frequencies.

13. The device according to claim 12, wherein the SEIRA sensor comprises:
a substrate; and
multiple pairs of nano-antennas disposed on the substrate in a lattice array, wherein any one of the multiple pairs of nano-antennas include:
a shorter nano-antenna; and
a longer nano-antenna, wherein the shorter nano-antenna and the longer nano-antenna are in alignment along an axis of symmetry bisecting one of the multiple pairs of nano-antennas.

14. The device according to claim 13, wherein each of the multiple pairs of nano-antennas is dimensionally configured to exhibit a broadband multi-resonance with various resonance wavelengths.

15. The device according to claim 13, wherein the nano-antennas are dimensionally configured to exhibit a plurality of resonances matching respective absorption regions characteristic of one or more target molecules in the sample.

16. The device according to claim 13, wherein the dimensions of the nano-antennas are determined to produce resonance wavelengths matching characteristic fingerprints of one or more target molecules obtained by the attenuated total reflection FTIR under vacuum condition.

17. The device according to claim 16, wherein the lattice array is characterized by a period of 3 μm, and
wherein the shorter nano-antenna is characterized by a length of 0.8 micrometers (μm), a width of 0.08 μm, and a height of 0.1 μm, and
wherein the longer nano-antenna is characterized by a length of 2.6 μm, a width of 0.4 μm, and a height of 0.1 μm, and
wherein the shortest spacing between the shorter dipole and the longer dipole is 1.5 μm.

18. The device according to claim 12, wherein the substrate is made of calcium difluoride (CaF₂) and the nano-antennas are made of gold (Au).

19. A method of testing a sample using the device according to claim 12, the sample being a mixed solution of one or more target molecules and one or more non-target molecules, the method comprising:
simultaneously acquiring a first Fourier transform infrared (FTIR) spectrum for each of a first well and a second well, the first well and the second well being selected from the plurality of wells and having dimensionally similar SEIRA sensors disposed therein, each of the SEIRA sensors including multiple pairs of nano-antennas patterned in a lattice array;
binding a first molecule to the multiple pairs of nano-antennas of the first well, the first molecule being complementary to a first target molecule;
binding a second molecule to the multiple pairs of nano-antennas of the second well, the second molecule being complementary to a second target molecule;
simultaneously acquiring a second Fourier transform infrared (FTIR) spectrum for each of the first well and the second well;
providing the mixed solution to the first well and the second well;
simultaneously acquiring a third FTIR spectrum for each of the first well and the second well; and
simultaneously determining a presence and/or a concentration of the first target molecule and a presence and/or a concentration of the second target molecule.

20. The method according to claim 19, the method comprising:
determining a first area ratio based on the first FTIR spectrum of the first cell, the second FTIR spectrum of the first cell, and the third FTIR spectrum of the first well; and
determining a second area ratio based on the first FTIR spectrum of the second well, the second FTIR spectrum of the second well, and the third FTIR spectrum of the second well, wherein the first area ratio and the second area ratio are indicative of respective concentrations of different target molecules in the mixed solution.
